(19) United States
(12) Patent Application Publication
(10) Pub. No.: US 2025/0196570 A1
(43) Pub. Date: Jun. 19, 2025

(54) HEAT MANAGEMENT SYSTEM FOR VEHICLE

(71) Applicant: HANON SYSTEMS, Daejeon (KR)

(72) Inventors: Ju Young Lim, Daejeon (KR); Gun Ryang Kim, Daejeon (KR); Dong Won Lee, Daejeon (KR); Hun Sang Lee, Daejeon (KR)

(21) Appl. No.: 18/847,301

(22) PCT Filed: Jul. 28, 2023
(86) PCT No.: PCT/KR2023/011044

§ 371 Date: Sep. 16, 2024

(30) Foreign Application Priority Data
Aug. 10, 2022 (KR) 10-2022-0099833
Aug. 10, 2022 (KR) 10-2022-0099848

(51) Int. Cl. B60H 1/00; B60H 1/32; F25B 43/02

(52) U.S. Cl. CPC B60H 1/00507; B60H 1/3229; F25B 43/02; B60H 2001/006

(57) ABSTRACT

The present invention relates to a heat management system for a vehicle, and more specifically, to a heat management system for a vehicle in which the refrigerant discharged from a compressor flows into a muffler to reduce the noise of the refrigerant, and the oil in the refrigerant is separated therefrom so that only the refrigerant flows to the indoor heat exchanger, and the separated oil is circulated back to the compressor, thereby improving the durability of the compressor.

### TECHNICAL FIELD

The present invention relates to a heat management system for a vehicle, which has noise reduction and an oil separation function.

### BACKGROUND ART

In a heat management system for a vehicle, refrigerant discharged from a compressor moves to a heat exchanger connected through a refrigerant line. A flow of the refrigerant generates large flow noise due to a pressure change, a speed, a phase change, etc.

To solve this problem, a muffler is connected to the refrigerant line connecting the compressor to the heat exchanger to reduce vibrations or noise of the refrigerant discharged from the compressor.

Meanwhile, the refrigerant discharged from the compressor contains a small amount of oil used for an operation of the compressor and is discharged.

In a typical compressor, an oil separator for separating and discharging oil when discharging refrigerant is installed, but its function is limited. Therefore, an oil shortage problem may occur in the compressor due to an continuous operation, resulting in degrading performance of the compressor and reducing durability thereof.

Therefore, there is a need to improve this.

### DISCLOSURE

### Technical Problem

The present invention has been made in efforts to solve the problems and is directed to providing a heat management system for a vehicle, which may efficiently separate and recover oil contained in refrigerant discharged from a compressor as well as reducing noise.

The objects of the present invention are not limited to the above-described object, and other objects that are not mentioned will be able to be clearly understood by those skilled in the art from the following description.

### Technical Solution

According to the present invention, there may be provided a heat management system for a vehicle, which comprises a compressor installed on a refrigerant circulation line and configured to compress and discharge refrigerant, an evaporator installed inside an air conditioning case and configured to exchange heat between air in the air conditioning case and the refrigerant supplied to the compressor, an outdoor heat exchanger installed outside the air conditioning case and configured to exchange heat between the refrigerant circulating through the refrigerant circulation line and outdoor air, and an expansion means installed on the refrigerant circulation line at an inlet side of the evaporator and configured to expand the refrigerant supplied to the evaporator, wherein a muffler installed at an outlet side of the compressor and configured to attenuate noise of the refrigerant discharged from the compressor, and an oil circulation line installed to directly or indirectly connect the muffler to the compressor are provided on the refrigerant circulation line, and the muffler may be configured to separate oil contained in the refrigerant discharged from the compressor, discharge only refrigerant separated from the oil through the refrigerant circulation line at an outlet side of the muffler, and discharge the separated oil to the compressor through the oil circulation line so that the oil circulates.

The muffler may have a cylindrical shape extending vertically, with a funnel-shaped structure that decreases in cross-sectional area from top to bottom, the muffler is configured to separate the refrigerant and the oil in a centrifugation manner by spirally rotating the refrigerant introduced into an internal space thereof.

The muffler may comprise a main body having the internal space, a refrigerant inlet provided on one side of the main body, configured to introduce refrigerant containing oil from outside into the internal space, a refrigerant outlet provided on the other side of the main body, configured to discharge the refrigerant separated from the oil in the internal space from the main body, and oil outlet provided on another side of the main body, configured to discharge the oil separated from the refrigerant in the internal space from the main body.

The main body may comprise an upper chamber having a cylindrical shape and a lower chamber having a funnel shape, and the refrigerant inlet is provided on a side surface of the upper chamber, the refrigerant outlet is provided on an upper surface of the upper chamber, and the oil outlet is provided at the center of the lower end of the lower chamber.

The refrigerant inlet may be connected to a centrifugation induction pipe extending from the side surface to the internal space, and the centrifugation induction pipe comprises a linear portion that extends horizontally toward a center of the upper chamber and a curved portion that is bent in a curved manner toward an inner circumferential surface of the upper chamber from a front end of the linear portion.

The main body may further comprise a collection chamber partially protruding upward from the center of the upper surface of the upper chamber, and the collection chamber is configured to have a diameter smaller than that of the upper chamber and to be connected to the refrigerant outlet.

The lower chamber may have a guide protrusion provided on an inner circumferential surface thereof, the guide protrusion is configured to guide the oil separated from the refrigerant to flow to the oil outlet while rotating along the inner circumferential surface.

The guide protrusion may comprise a plurality of guide protrusions arranged along the inner circumferential surface.

The guide protrusion may be provided with a curved shape corresponding to a rotation direction of the oil and extends from an upper side of the lower chamber toward the oil outlet at a lower side thereof.

A filter configured to remove foreign substances contained in the separated oil may be installed on the oil outlet.

The oil circulation line may be connected to the refrigerant circulation line at the inlet side of the compressor.

The oil circulation line may be configured to have a diameter smaller than that of the refrigerant circulation line.

The compressor may comprise a low-pressure section at a front end where the refrigerant is introduced, a high-pressure section at a rear end where the refrigerant and the oil are discharged, and an intermediate-pressure section between the low-pressure section and the high-pressure section, and the oil circulation line is connected to either the low-pressure section or the intermediate-pressure section.

An expansion valve or an orifice may be installed on the oil circulation line.

The heat management system may further comprise an indoor heat exchanger installed inside the air conditioning case, configured to exchange heat between the air in the air conditioning case and the refrigerant discharged from the compressor, wherein the muffler is configured to discharge only the refrigerant separated from the oil to the indoor heat exchanger through the refrigerant circulation line.

### Advantageous Effects

According to the embodiments of the present invention, the noise of the refrigerant discharged from the compressor can be reduced and the oil contained in the refrigerant can be efficiently separated and recovered, and the separated oil can be circulated back to the compressor, thereby increasing the durability of the compressor.

The effects of the present invention are not limited to the above-described effects, and other effects that are not mentioned will be able to be clearly understood by those skilled in the art from the following description.

### DESCRIPTION OF DRAWINGS

FIG. 1 is a view schematically showing a heat management system for a vehicle according to an embodiment of the present invention.

FIG. 2 is a configuration diagram schematically showing an air conditioner mode in the heat management system for a vehicle of FIG. 1.

FIG. 3 is a configuration diagram schematically showing a heat pump mode in the heat management system for a vehicle of FIG. 1.

FIG. 4 is a configuration diagram schematically showing a connection structure of a muffler and an oil circulation line in the heat management system for a vehicle of FIG. 1.

FIG. 5 is a configuration diagram schematically showing another connection structure of the muffler and the oil circulation line in the heat management system for a vehicle of FIG. 1.

FIG. 6 is a view schematically showing the muffler according to an embodiment of the present invention.

FIG. 7 is a cross-sectional view schematically showing the muffler of FIG. 6.

FIG. 8 is a cross-sectional view schematically showing a cross section along line I-I in FIG. 7.

FIG. 9 is a view schematically showing a muffler according to another embodiment of the present invention.

FIG. 10 is a cross-sectional view schematically showing the muffler of FIG. 9.

FIG. 11 is a cross-sectional view schematically showing a muffler according to still another embodiment of the present invention.

FIG. 12 is a cross-sectional view schematically showing the muffler of FIG. 11.

### MODE FOR INVENTION

Since the present invention may have various changes and various embodiments, specific embodiments are illustrated and described in the accompanying drawings. However, it should be understood that it is not intended to limit specific embodiments, and it should be understood to include all modifications, equivalents, and substitutes included in the spirit and scope of the present invention. Terms including ordinal numbers such as first or second may be used to describe various components, but the components are not limited by the terms. The terms are used only for the purpose of distinguishing one component from another. For example, a second component may be referred to as a first component, and similarly, the first component may also be referred to as the second component without departing from the scope of the present invention. The term “and/or” includes a combination of a plurality of related listed items or any of the plurality of related listed items.

When a first component is described as being “connected” or “coupled” to a second component, it should be understood that the first component may be directly connected or coupled to the second component or a third component may be present therebetween. On the other hand, when a certain component is described as being “directly connected” or “directly coupled” to another component, it should be understood that others components are not present therebetween.

In the description of the embodiment, in a case in which one component is described as being formed “on (above)” or “below (under)” another component, “on (above)” or “below (under)” includes both a case in which two components are in direct contact with each other or a case in which one or more other components are disposed between the two components. In addition, when described as “on (above)” or “below (under),” it may include the meaning of not only an upward direction but also a downward direction with respect to one component.

The terms used in the present application are only used to describe specific embodiments and are not intended to limit the present invention. The singular includes the plural unless the context clearly dictates otherwise. In the application, it should be understood that terms “include” and “have” are intended to specify that a feature, a number, a step, an operation, a component, a part, or a combination thereof described in the specification is present, but do not preclude the possibility of the presence or addition of one or more other features, numbers, steps, operations, components, parts, or combinations thereof.

Unless defined otherwise, all terms used herein, including technical or scientific terms, have the same meaning as commonly understood by those skilled in the art to which the present invention pertains. The terms defined in a generally used dictionary should be construed as meanings that match with the meanings of the terms from the context of the related technology and are not construed as an ideal or excessively formal meaning unless clearly defined in this application.

Hereinafter, embodiments will be described in detail with reference to the accompanying drawings, and the same or corresponding components are denoted by the same reference numeral regardless of the reference numerals, and overlapping descriptions thereof will be omitted.

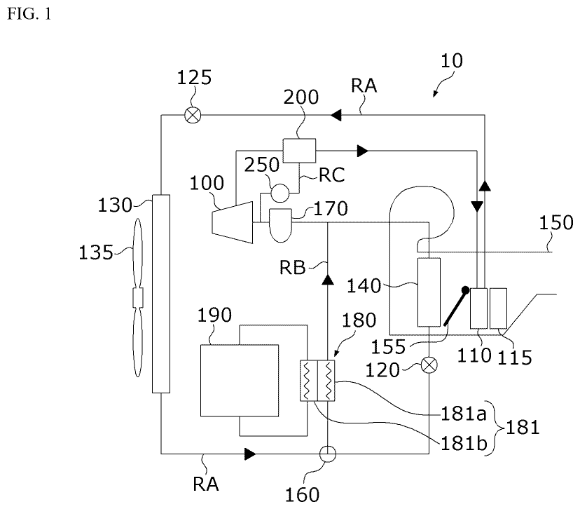

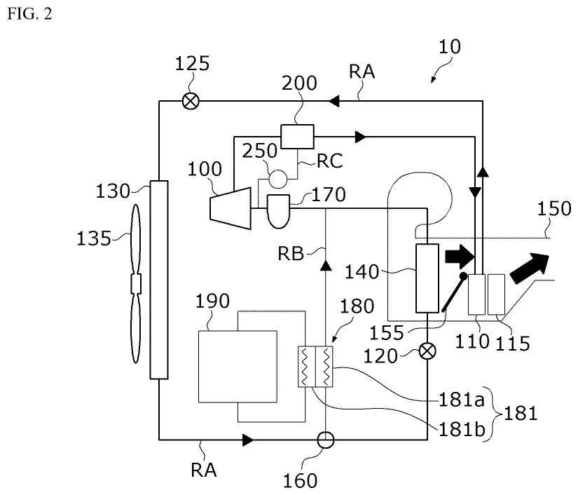

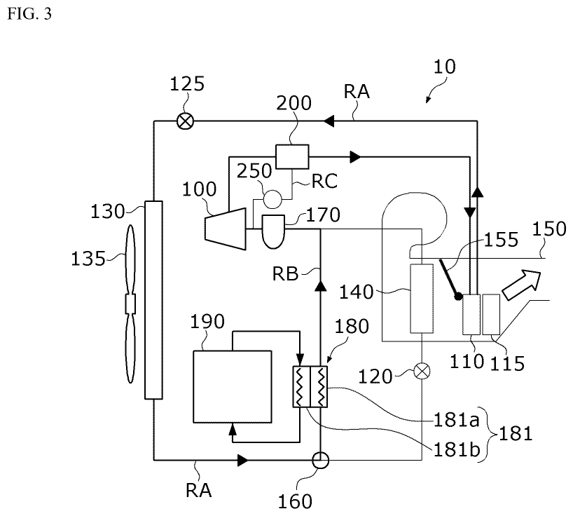

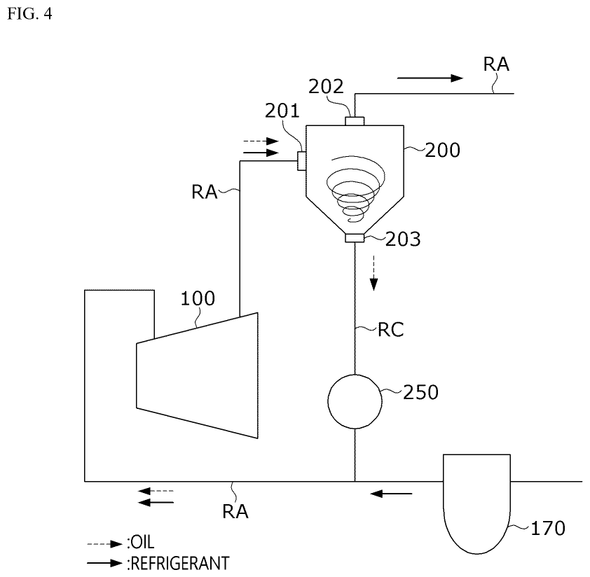

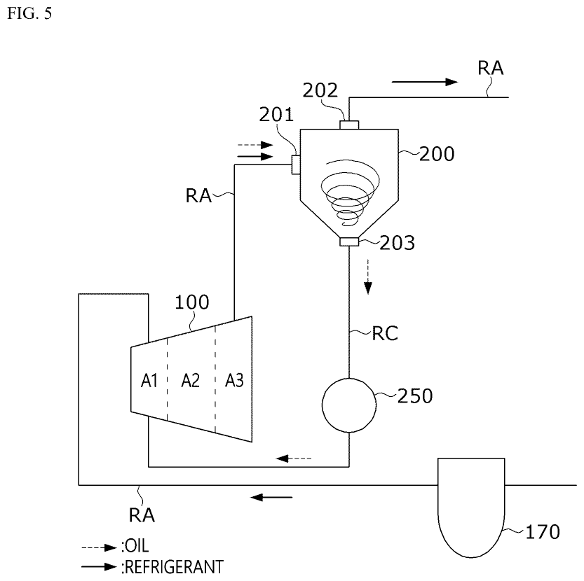

FIG. 1 is a view schematically showing a heat management system for a vehicle according to an embodiment of the present invention, FIG. 2 is a configuration diagram schematically showing an air conditioner mode in the heat management system for a vehicle of FIG. 1, and FIG. 3 is a configuration diagram schematically showing a heat pump mode in the heat management system for a vehicle of FIG. 1. FIG. 4 is a configuration diagram schematically showing a connection structure of a muffler and an oil circulation line in the heat management system for a vehicle of FIG. 1, and FIG. 5 is a configuration diagram schematically showing another connection structure of the muffler and the oil circulation line in the heat management system for a vehicle of FIG. 1.

Referring to the drawings, a heat management system 10 for a vehicle according to the embodiment of the present invention is configured by sequentially connecting a compressor 100, an indoor heat exchanger 110, an expansion means 120, an outdoor heat exchanger 130, and an evaporator 140 on a refrigerant circulation line RA and may be applied to electric vehicles, hybrid electric vehicles, etc. Of course, the heat management system for a vehicle may be applied to general internal combustion engine vehicles.

In addition, a bypass line RB that bypasses the expansion means 120 and the evaporator 140 may be installed on the refrigerant circulation line RA, and a direction change valve 160 may be installed at a branch point of the bypass line RB.

Therefore, in an air conditioner mode, as shown in FIG. 2, the refrigerant discharged from the compressor 100 may be configured to circulate sequentially through the indoor heat exchanger 110, the outdoor heat exchanger 130, the expansion means 120, the evaporator 140, and the compressor 100. In this case, the indoor heat exchanger 110 serves as a condenser, and the evaporator 140 serves as an evaporator. In addition, the outdoor heat exchanger 130 serves as a condenser like the indoor heat exchanger 110.

In a heat pump mode, as shown in FIG. 3, refrigerant discharged from the compressor 100 may be configured to sequentially circulate through the indoor heat exchanger 110, an external expansion means 125, the outdoor heat exchanger 130, the bypass line RB, and the compressor 100. In this case, the indoor heat exchanger 110 serves as a condenser, and the outdoor heat exchanger 130 serves as an evaporator.

As described above, since refrigerant circulation directions are the same in the air conditioner mode and the heat pump mode, the refrigerant circulation line RA can be shared, the refrigerant stagnation phenomenon that occurs when the refrigerant does not flow can be prevented, and the refrigerant circulation line RA can also be simplified.

Hereinafter, each component of the heat management system 10 for a vehicle will be described.

The compressor 100 is driven by receiving power from an engine, a motor, etc. to compress the introduced refrigerant and then discharge the refrigerant in a high-temperature, high-pressure gaseous state.

In the air conditioner mode, the compressor 100 compresses the refrigerant introduced after being discharged from the evaporator 140 side and supplies the compressed refrigerant to the indoor heat exchanger 110, and in the heat pump mode, compresses the refrigerant discharged from the outdoor heat exchanger 130 side and introduced through the bypass line RB and supplies the compressed refrigerant to the indoor heat exchanger 110 side.

The indoor heat exchanger 110 is installed inside an air conditioning case 150 and is configured to be connected to the refrigerant circulation line RA at an outlet side of the compressor 100 to exchange heat between air flowing inside the air conditioning case 150 and the refrigerant discharged from the compressor 100.

In addition, the evaporator 140 is installed inside the air conditioning case 150 and is configured to be connected to the refrigerant circulation line RA at an inlet side of the compressor 100 to exchange heat between the air flowing inside the air conditioning case 150 and refrigerant flowing to the compressor 100.

As shown in the drawing, the indoor heat exchanger 110 and the evaporator 140 may be installed to be spaced a predetermined distance from each other inside the air conditioning case 150. In this case, the evaporator 140 and the indoor heat exchanger 110 may be installed sequentially from an upstream side in an air flow direction inside the air conditioning case 150.

Therefore, in the air conditioner mode, low-temperature, low-pressure refrigerant discharged from the expansion means 120 is supplied to the evaporator 140, and at this time, air flowing inside the air conditioner case 150 through a blower (not shown) exchanges heat with the low-temperature, low-pressure refrigerant inside the evaporator 140 while passing through the evaporator 140, is changed to cold wind, and then is discharged to a vehicle interior for cooling.

In the heat pump mode, the high-temperature, high-pressure refrigerant discharged from the compressor 100 is supplied to the indoor heat exchanger 110, and the air flowing inside the air conditioner case 150 through the blower (not shown) exchanges heat with the high-temperature, high-pressure refrigerant inside the indoor heat exchanger 20 while passing through the indoor heat exchanger 20, is changed to hot wind, and then is discharged to the vehicle interior for heating.

Inside the air conditioning case 150, a temperature control door 155 for controlling the amount of air bypassing the indoor heat exchanger 110 and the amount of air passing through the same may be installed between the evaporator 140 and the indoor heat exchanger 110.

In addition, inside the air conditioning case 150, an electric heating heater 115 may be further installed adjacent to a downstream side of the indoor heat exchanger 110 to improve heating performance. In an embodiment, the electric heating heater 115 may include a PTC heater.

The outdoor heat exchanger 130 is installed outside the air conditioning case 150 and is connected to the refrigerant circulation line RA to exchange heat between the refrigerant circulating in the refrigerant circulation line RA and outside air.

In an embodiment, the outdoor heat exchanger 130 may be installed at a front side of a vehicle engine room, and a fan 135 for forcibly blowing the outside air to the outdoor heat exchanger 130 side may be provided at one side thereof.

The external expansion means 125 is installed on the refrigerant circulation line RA between the indoor heat exchanger 110 and the outdoor heat exchanger 130 and selectively expands the refrigerant supplied to the outdoor heat exchanger 130 side according to the air conditioner mode or the heat pump mode.

The bypass line RB is installed to connect the refrigerant circulation line RA at the inlet side of the expansion means 120 to the refrigerant circulation line RA at the outlet side of the evaporator 140 and allows the refrigerant circulating on the refrigerant circulation line RA to selectively bypass the expansion means 120 and the evaporator 140.

The direction change valve 160 is installed at a branch point of the bypass line RB and the refrigerant circulation line RA, and the direction of the flow of the refrigerant passing through the outdoor heat exchanger 130 is changed so that the refrigerant flows to the bypass line RB or the expansion means 120 according to the air conditioner mode or the heat pump mode.

A heat supply means 180 for supplying heat to the refrigerant flowing along the bypass line RB may be installed on the bypass line RB.

The heat supply means 180 may be configured by installing a water-cooled heat exchanger 181 including a refrigerant heat exchange part 181a through which refrigerant flowing through the bypass line RB flows and a coolant heat exchange part 181b which is provided at one side of the refrigerant heat exchange part 181a to enable heat exchange and through which cooling water circulating through a vehicle electrical component 190 flows so that waste heat of the vehicle electrical component 190 may be supplied to the refrigerant flowing through the bypass line RB.

Therefore, in the heat pump mode, the coolant circulating through the coolant heat exchange part 181b may supply the waste heat of the vehicle electrical component 190 to the refrigerant circulating through the refrigerant heat exchange part 181a on the bypass line RB, and a heat resource may be recovered from the waste heat of the vehicle electric component 190, thereby improving heating performance.

In an embodiment, the vehicle electrical component 190 may include, representatively, a motor, an inverter, etc.

An accumulator 170 may be installed on the refrigerant circulation line RA at the inlet side of the compressor 100.

The accumulator 170 separates liquid refrigerant and gaseous refrigerant from the refrigerant supplied to the compressor 100 so that only the gaseous refrigerant may be supplied to the compressor 100.

Referring to the drawing, a muffler 200 may be installed on the refrigerant circulation line RA connecting the compressor 100 to the indoor heat exchanger 110.

The muffler 200 may be provided to reduce noise generated by the refrigerant discharged from the compressor 100 and separate oil contained in the refrigerant.

The refrigerant discharged from the compressor 100 generates significantly large flow noise due to complex factors such as a phase change, a pressure change, and a speed change.

In addition, the refrigerant discharged from the compressor 100 is discharged in a state of containing a small amount of oil. In the typical compressor 100, an oil separator (not shown) is installed inside the outlet side to separate and discharge oil when discharging refrigerant, but its function is limited. Therefore, an oil shortage problem may occur in the compressor 100 due to an continuous operation, resulting in degrading performance of the compressor 100 and reducing durability thereof.

The muffler 200 may be installed on the refrigerant circulation line RA at the outlet side of the compressor 100 to reduce such noise and may also be provided to separate the oil contained in the refrigerant.

Meanwhile, an oil circulation line RC may be installed on the refrigerant circulation line RA to connect the muffler 200 to the compressor 100.

The oil circulation line RC may be installed to be directly or indirectly connected to the compressor 100, and a drain loop circuit for sending the oil separated from the refrigerant in the muffler 200 back to the compressor 100 to circulate may be implemented.

As described above, the muffler 200 according to the present embodiment is installed on the refrigerant circulation line RA at the outlet side of the compressor 100 to reduce the noise of the refrigerant introduced from the compressor 100 and separates the oil contained in the refrigerant. In addition, by discharging only the gaseous refrigerant from separated from the oil to the indoor heat exchanger 110 through the refrigerant circulation line RA and discharging the separated oil to the compressor 100 through the oil circulation line RC, the muffler 200 is configured so that the oil circulates in connection with the oil circulation line RC.

As shown in the drawing, the muffler 200 may have a funnel-shaped structure in which a cross-sectional area decreases from the top to the bottom in a cylindrical shape extending vertically. In addition, the muffler 200 may be configured so that the refrigerant and the oil are separated by centrifugation by spirally rotating the refrigerant flowing into an internal space.

The muffler 200 may have a refrigerant inlet 201 through which the refrigerant discharged from the compressor 100 is introduced on an upper side surface and may be connected to the refrigerant circulation line RA at the outlet side of the compressor 100. In addition, the muffler 200 may have a refrigerant outlet 202 for discharging the refrigerant separated from the oil on an upper surface thereof and may be connected to the refrigerant circulation line RA at the inlet side of the indoor heat exchanger 110. Therefore, the gaseous refrigerant separated from the oil by centrifugation while spirally rotating in the internal space of the muffler 200 is discharged through the refrigerant outlet 202 at the upper side and flows to the indoor heat exchanger 110 along the refrigerant circulation line RA. In this case, only the gaseous refrigerant may be supplied to the indoor heat exchanger 110, thereby increasing heat dissipation.

In addition, the muffler 200 may be connected to the oil circulation line RC by having an oil outlet 203 for discharging separated oil at a lower center thereof.

As shown in FIG. 4, the oil circulation line RC may be connected to the refrigerant circulation line RA at the inlet side of the compressor 100, and thus the muffler 200 may be indirectly connected to the compressor 100 through the oil circulation line RC.

As the refrigerant flowing into the inner space from the top of the muffler 200 spirally rotates in the internal space, oil with high viscosity and specific gravity may be separated from the refrigerant by centrifugation, precipitated to a lower end of the muffler 200, discharged through the oil outlet 203, and recovered back to the compressor 100 together with the refrigerant after flowing to the refrigerant circulation line RA at the inlet side of the compressor 100 along the oil circulation line RC.

In this case, the oil circulation line RC may be configured to have a smaller diameter than the refrigerant circulation line RA. It is intended to prevent a problem that when the diameter of the oil circulation line RC is greater than the diameter of the refrigerant circulation line RA to which the oil circulation line RC is connected, a flow rate of the refrigerant recovered to the compressor 100 may increase, resulting in degradation of cooling performance. That is, since it is realistically difficult to completely separate refrigerant and oil, the oil recovered to the compressor 100 through the oil circulation line RC may contain a small amount of refrigerant. The increase in the flow rate of the recovered refrigerant causes degradation of cooling performance. Therefore, by making the diameter of the oil circulation line RC smaller than the diameter of the refrigerant circulation line RA, it is possible to prevent the degradation of cooling performance.

An expansion valve 250 may be installed on the oil circulation line RC. Of course, an orifice may be installed instead of the expansion valve 250.

As shown in FIG. 5, the oil circulation line RC may be connected to the compressor 100, and thus the muffler 200 may be directly connected to the compressor 100 through the oil circulation line RC.

The compressor 100 may include a low-pressure section A1 at a front end where the refrigerant is introduced, a high-pressure section A3 at a rear end where the refrigerant and the oil are discharged, and an intermediate-pressure section A2 between the low-pressure section A1 and the high-pressure section A3.

In addition, the oil circulation line RC may be connected to any one side of the low-pressure section A1 or the intermediate-pressure section A2 of the compressor 100. In the drawing, the oil circulation line RC is shown as being connected to the low-pressure section A1 of the compressor 100, but is not limited thereto. For example, the oil circulation line RC may also be connected to the intermediate-pressure section A2 of the compressor 100.

Therefore, the oil smoothly flows to the compressor 100 by a differential pressure acting in the oil circulation line RC and is re-injected into the compressor 100. Therefore, it is possible to prevent the oil shortage problem in the compressor 100, thereby increasing the durability of the compressor 100.

Hereinafter, the above-described structure of the muffler 200 will be described in more detail.

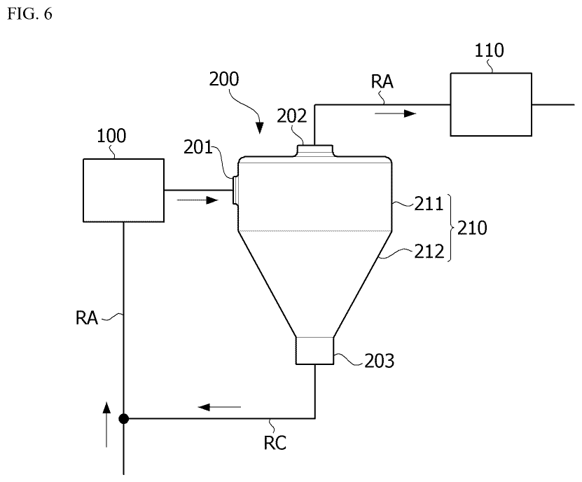

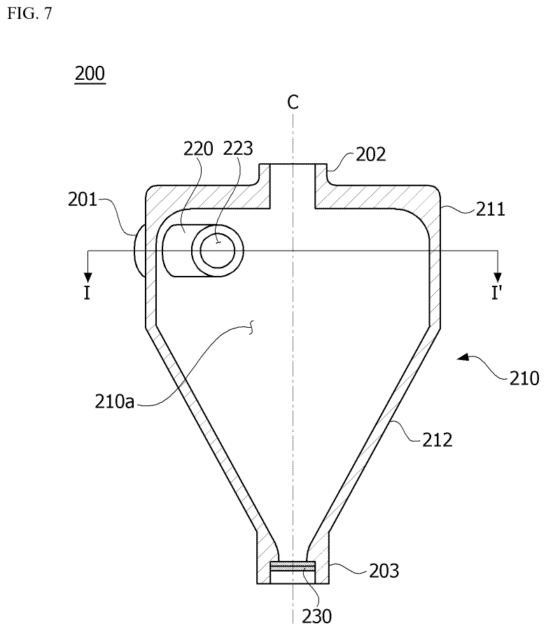

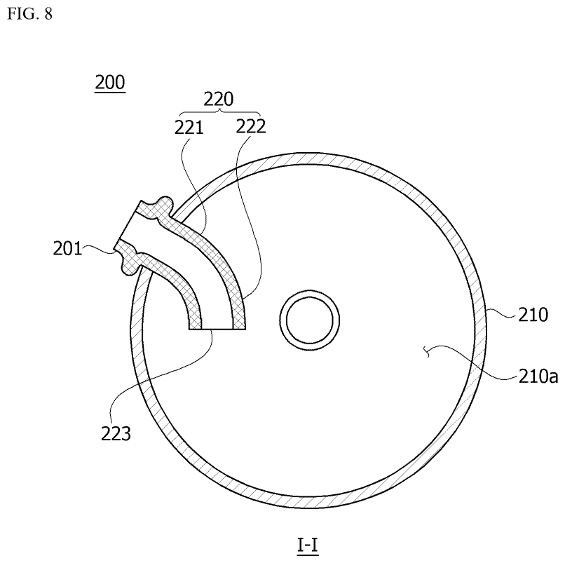

FIG. 6 is a view schematically showing the muffler according to an embodiment of the present invention, FIG. 7 is a cross-sectional view schematically showing the muffler of FIG. 6, and FIG. 8 is a cross-sectional view schematically showing a cross section along line I-I in FIG. 7.

Referring to the drawings, the muffler 200 according to the embodiment of the present invention may include a main body 210, the refrigerant inlet 201, the refrigerant outlet 202, and the oil outlet 203.

The main body 210 is a housing member having an internal space 210a and may be configured to separate the oil and the refrigerant in the internal space 210a when refrigerant containing oil is introduced.

The main body 210 may include an upper chamber 211 and a lower chamber 212 disposed under the upper chamber 211.

The upper chamber 211 may be formed entirely in a cylindrical shape, and the lower chamber 212 may be formed entirely in a funnel shape. In addition, a lower end of the upper chamber 211 and an upper end of the lower chamber 212 may be integrally connected to form the single main body 210.

As described above, the main body 210 may have an overall structure in which a cross-sectional area decreases from the top to the bottom.

The refrigerant inlet 201 may allow the refrigerant containing oil to flow into the internal space 210a of the main body 210 from the outside.

The refrigerant inlet 201 may be provided at one side of the main body 210 and provided on a side surface of the upper chamber 211. The refrigerant inlet 201 may be connected to the compressor 100 through the refrigerant circulation line RA.

The high temperature and high pressure refrigerant discharged from the compressor 100 may flow into the internal space 210a of the main body 210 through the refrigerant inlet 201 along the refrigerant circulation line RA in an oil-containing state.

As shown in the drawings, the refrigerant inlet 201 may be connected to a centrifugation induction pipe 220 that is provided to extend from the side surface of the main body 210 to the internal space 210a.

The centrifugation induction pipe 220 may include a linear portion 221 that extends horizontally toward the center of the upper chamber 211 and a curved portion 222 that is bent in a curved manner toward an inner circumferential surface of the upper chamber 211 from a front end of the linear portion 221.

The front end of the curved portion 222 is preferably disposed substantially in the middle between the inner surface of the upper chamber 211 and a central axis C of the upper chamber 211 when viewed from the top. In addition, an opening 223 provided at the front end of the curved portion 222 may be disposed in a structure that obliquely faces the inner surface of the upper chamber 211.

When the front end of the curved portion 222 extends too deeply to the central axis of the upper chamber 211, a centrifugal force for separating oil and refrigerant is not sufficiently generated, and when extending too shallowly adjacent to the inner circumferential surface of the upper chamber 211, refrigerant discharged from the opening 223 may collide strongly with the above inner circumferential surface and may not rotate along the above inner circumferential surface.

As described above, the oil-containing refrigerant flowing into the internal space through the centrifugation induction pipe 220 moves downward while rotating along the inner circumferential surface of the upper chamber 211, and the refrigerant and the oil may be separated by centrifugation by spirally rotating along the inner circumferential surface of the lower chamber 212.

In particular, since the lower chamber 212 has a funnel-shaped structure in which the cross-sectional area decreases toward a lower portion thereof, a spiral rotation speed along the inner circumferential surface of the lower chamber 212 is gradually faster, and thus the oil with relatively high viscosity and specific gravity can be effectively separated from the refrigerant and precipitated at a lower end of the lower chamber 212.

The refrigerant outlet 202 may discharge the refrigerant separated from the oil in the internal space 210a from the main body 210.

The refrigerant outlet 202 may be provided at the other side of the main body 210 and provided on an upper surface of the upper chamber 211. The refrigerant outlet 202 may be connected to the indoor heat exchanger 110 through the refrigerant circulation line RA.

The refrigerant outlet 202 is provided on the upper surface of the upper chamber 211 so that the gaseous refrigerant separated from the oil may be smoothly discharged. In addition, only the refrigerant separated from the oil may be supplied to the indoor heat exchanger 110 along the refrigerant circulation line RA to increase heat dissipation.

The oil outlet 203 may discharge the oil separated from the refrigerant in the internal space 210a from the main body 210.

The oil outlet 203 may be provided at another other side of the main body 210 and provided on a lower end center of the lower chamber 212. The oil outlet 203 may be connected to the compressor 100 through the oil circulation line RC.

The oil separated from the refrigerant is collected by spirally rotating along the inner circumferential surface of the lower chamber 212 and moving downward by gravity. Therefore, for smooth discharge of the oil, the oil outlet 203 is provided at the lower end center of the lower chamber 212.

The liquid oil collected at the lower end of the lower chamber 212 through the collision with the inner surface of the main body 210 and the spiral rotation may be circulated to the compressor 100 along the oil circulation line RC connected to the oil outlet 203 in a reduced temperature state. Therefore, it is possible to increase the durability of the compressor 100.

In an embodiment, the oil outlet 203 may be provided with a filter 230 for removing a foreign substance contained in the separated oil.

Meanwhile, the refrigerant outlet 202 and the oil outlet 203 may be configured to be disposed on the same axis. That is, the center of the refrigerant outlet 202 and the center of the oil outlet 203 may be disposed on the same central axis C.

Of course, the arrangement structure of the refrigerant outlet 202 and the oil outlet 203 is not limited thereto, and according to an embodiment, the refrigerant outlet 202 and the oil outlet 203 may be disposed on different axes.

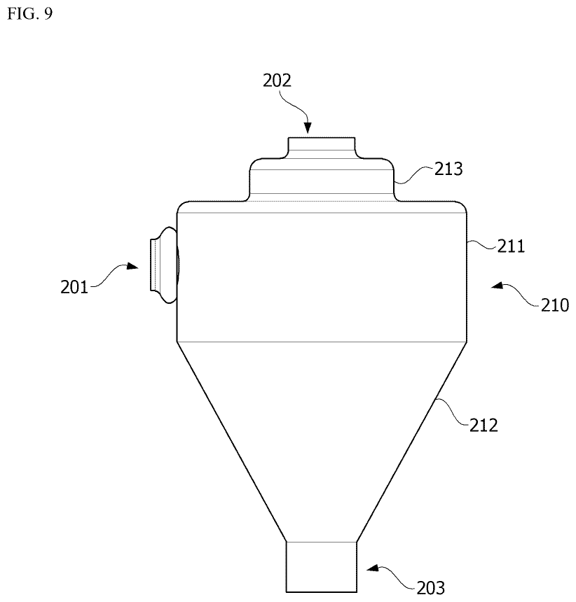

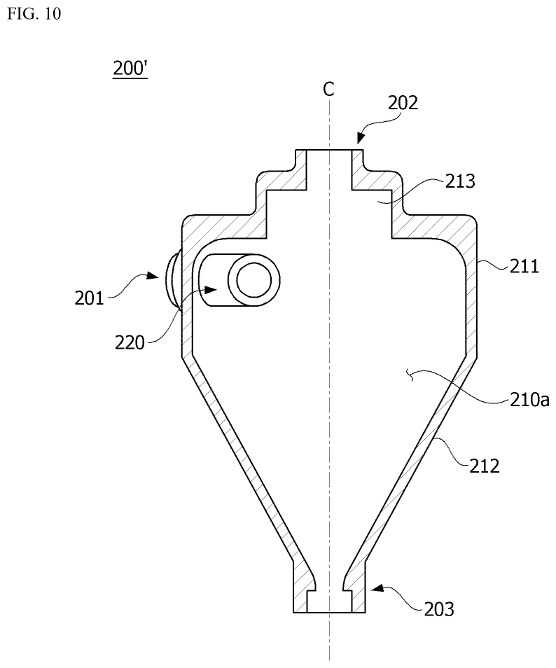

FIGS. 9 and 10 schematically show a muffler 200′ according to another embodiment of the present invention.

The muffler 200′ according to the embodiment shown in FIGS. 9 and 10 has a basic configuration that is substantially the same as that of the muffler 200 according to the embodiment shown in FIG. 6. However, the muffler 200′ according to the embodiment shown in FIGS. 9 and 10 differs in that the main body 210 further includes a collection chamber 213. Hereinafter, differences will be mainly described.

FIG. 9 is a view schematically showing a muffler according to another embodiment of the present invention, and FIG. 10 is a cross-sectional view schematically showing the muffler of FIG. 9.

Referring to the drawings, the main body 210 may further include the collection chamber 213 provided in the upper chamber 211.

The collection chamber 213 may be provided as a space in which the gaseous refrigerant separated from oil is collected in the upper portion of the upper chamber 211.

As shown in the drawings, the collection chamber may have a smaller diameter than the upper chamber 211 and may be provided in a structure that partially protrudes upward from the center of the upper surface of the upper chamber 211.

In addition, the refrigerant outlet 202 may be connected to an upper surface of the collection chamber 213.

The collection chamber 213 may allow the gaseous refrigerant separated from the oil to be collected in an upper central area of the upper chamber 211 and discharged through the refrigerant outlet 202, thereby smoothly and efficiently discharging the refrigerant.

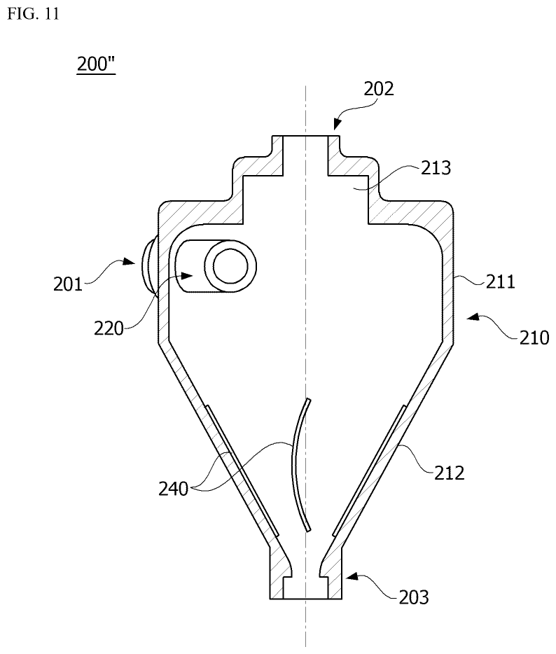

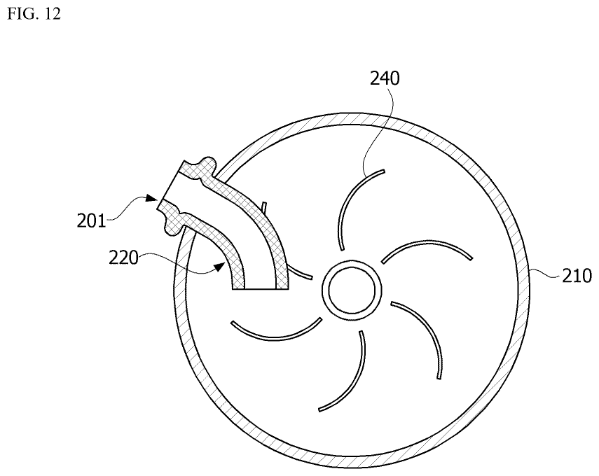

FIGS. 11 and 12 schematically show a muffler 200″ according to still another embodiment of the present invention.

The muffler 200″ according to the embodiment shown in FIGS. 11 and 12 has a basic configuration that is substantially the same as that of the muffler 200′ according to the embodiment shown in FIG. 9. However, the muffler 200″ according to the embodiment shown in FIGS. 11 and 12 differs in that the main body 210 has a guide protrusion 240. Hereinafter, differences will be mainly described.

FIG. 11 is a cross-sectional view schematically showing a muffler according to still another embodiment of the present invention, and FIG. 12 is a cross-sectional view schematically showing the muffler of FIG. 11.

Referring to the drawings, the lower chamber 212 of the main body 210 may have the guide protrusion 240 on an inner circumferential surface thereof.

The guide protrusion 240 is formed by protruding from the inner circumferential surface of the lower chamber 212, and a plurality of guide protrusions may be provided to be arranged at a predetermined interval along the above inner circumferential surface.

The guide protrusion 240 may guide the oil separated from the refrigerant by centrifugation in the internal space of the main body 210 to be moved to the oil outlet 203 by gravity while rotating along the inner circumferential surface of the lower chamber 212.

The guide protrusion 240 may be provided in a structure that extends from an upper side of the lower chamber 212 to the oil outlet 203 at a lower side thereof in a curved shape corresponding to the rotation direction of the oil.

As described above, according to the embodiment of the present invention, it is possible to reduce noise due to the flow of refrigerant, and at the same time, the oil contained in the refrigerant discharged from the compressor 100 can be efficiently separated by centrifugation to send only the refrigerant to the indoor heat exchanger 110, thereby increasing heat dissipation.

In addition, it is possible to increase the durability of the compressor 100 by re-circulating the separated oil back to the compressor 100.

Although the above description has been made with reference to the embodiments of the present invention, those skilled in the art will be able to understand that the present invention can be modified and changed variously without departing from the spirit and scope of the present invention described in the appended claims. In addition, differences related to these modifications and changes should be construed as being included in the scope of the present invention defined in the appended claims.

1. A heat management system for a vehicle, which comprises a compressor installed on a refrigerant circulation lines and configured to compress and discharge refrigerant, an evaporator installed inside an air conditioning case and configured to exchange heat between air in the air conditioning case and the refrigerant supplied to the compressor, an outdoor heat exchanger installed outside the air conditioning case and configured to exchange heat between the refrigerant circulating through the refrigerant circulation line and outdoor air, and an expansion means installed on the refrigerant circulation line at an inlet side of the evaporator and configured to expand the refrigerant supplied to the evaporator,
wherein a muffler installed at an outlet side of the compressor and configured to attenuate noise of the refrigerant discharged from the compressor, and an oil circulation line installed to directly or indirectly connect the muffler to the compressor are provided on the refrigerant circulation line, and
wherein the muffler is configured to separate oil contained in the refrigerant discharged from the compressor, discharge only refrigerant separated from the oil through the refrigerant circulation line at an outlet side of the muffler, and discharge the separated oil to the compressor through the oil circulation line so that the oil circulates.

2. The heat management system of claim 1, wherein the muffler has a cylindrical shape extending vertically, with a funnel-shaped structure that decreases in cross-sectional area from top to bottom, the muffler is configured to separate the refrigerant and the oil in a centrifugation manner by spirally rotating the refrigerant introduced into an internal space thereof.

3. The heat management system of claim 2, wherein the muffler comprises:
a main body having the internal space;
a refrigerant inlet provided on one side of the main body, configured to introduce refrigerant containing oil from outside into the internal space;
a refrigerant outlet provided on the other side of the main body, configured to discharge the refrigerant separated from the oil in the internal space from the main body; and
an oil outlet provided on another side of the main body, configured to discharge the oil separated from the refrigerant in the internal space from the main body.

4. The heat management system of claim 3, wherein the main body comprises an upper chamber having a cylindrical shape and a lower chamber having a funnel shape, and the refrigerant inlet is provided on a side surface of the upper chamber, the refrigerant outlet is provided on an upper surface of the upper chamber, and the oil outlet is provided at the center of the lower end of the lower chamber.

5. The heat management system of claim 4, wherein the refrigerant inlet is connected to a centrifugation induction pipe extending from the side surface to the internal space, and
the centrifugation induction pipe comprises a linear portion that extends horizontally toward a center of the upper chamber and a curved portion that is bent in a curved manner toward an inner circumferential surface of the upper chamber from a front end of the linear portion.

6. The heat management system of claim 4, wherein the main body further comprises a collection chamber partially protruding upward from the center of the upper surface of the upper chamber, and the collection chamber is configured to have a diameter smaller than that of the upper chamber and to be connected to the refrigerant outlet.

7. The heat management system of claim 4, wherein the lower chamber has a guide protrusion provided on an inner circumferential surface thereof, the guide protrusion is configured to guide the oil separated from the refrigerant to flow to the oil outlet while rotating along the inner circumferential surface.

8. The heat management system of claim 7, wherein the guide protrusion comprises a plurality of guide protrusions arranged along the inner circumferential surface.

9. The heat management system of claim 7, wherein the guide protrusion is provided with a curved shape corresponding to a rotation direction of the oil and extends from an upper side of the lower chamber toward the oil outlet at a lower side thereof.

10. The heat management system of claim 3, wherein a filter configured to remove foreign substances contained in the separated oil is installed on the oil outlet.

11. The heat management system of claim 1, wherein the oil circulation line is connected to the refrigerant circulation line at the inlet side of the compressor.

12. The heat management system of claim 11, wherein the oil circulation line is configured to have a diameter smaller than that of the refrigerant circulation line.

13. The heat management system of claim 1, wherein the compressor comprises a low-pressure section at a front end where the refrigerant is introduced, a high-pressure section at a rear end where the refrigerant and the oil are discharged, and an intermediate-pressure section between the low-pressure section and the high-pressure section, and the oil circulation line is connected to either the low-pressure section or the intermediate-pressure section.

14. The heat management system of claim 1, wherein an expansion valve or an orifice is installed on the oil circulation line.

15. The heat management system of claim 1, further comprising an indoor heat exchanger installed inside the air conditioning case, configured to exchange heat between the air in the air conditioning case and the refrigerant discharged from the compressor, wherein the muffler is configured to discharge only the refrigerant separated from the oil to the indoor heat exchanger through the refrigerant circulation line.
